(19) United States
(12) Patent Application Publication
(10) Pub. No.: US 2012/0149517 A1
(43) Pub. Date: Jun. 14, 2012

(54) HUB MOTOR UNIT FOR ELECTRIC BICYCLE

(75) Inventors: Jeong Han Ko, Seoul (KR); Kyung Phil Kang, Gyunggi-Do (KR)

(73) Assignee: Hyundai Motor Company, Seoul (KR)

(21) Appl. No.: 13/173,802

(22) Filed: Jun. 30, 2011

(30) Foreign Application Priority Data
Dec. 8, 2010 (KR) 10-2010-0124920

(51) Int. Cl. F16H 3/72

(52) U.S. Cl. 475/5

(57) ABSTRACT

A hub motor unit for an electric bicycle may include a hollow shaft mounted at a bicycle frame, a shifting portion having an input element rotatably mounted at the hollow shaft and an output element, a driven sprocket mounted at the input element, a hub housing rotatably mounted at an exterior circumference of the input element, and having an interior circumference fixedly connected to the output element of the shifting portion and an exterior circumference connected to a wheel through a spoke, a hub cover rotatably mounted at the hollow shaft and coupled to the hub housing, a motor portion mounted between the hollow shaft and the input element in the hub housing and supplying torque to the shifting portion through the input element according to a control signal, and a shift control portion mounted on a shift shaft in the hollow shaft and controlling the shifting portion.

### CROSS-REFERENCE TO RELATED APPLICATION

The present application claims priority to Korean Patent Application No. 10-2010-0124920 filed in the Korean Intellectual Property Office on Dec. 8, 2010, the entire contents of which is incorporated herein for all purposes by this reference.

### BACKGROUND OF THE INVENTION

1. Field of the Invention

The present invention relates to a hub motor unit for an electric bicycle. More particularly, the present invention relates to a hub motor unit for an electric bicycle that is integrally mounted at a hub of a rear wheel of an electric bicycle.

2. Description of Related Art

A hub motor unit for an electric bicycle has problems such that overload may be applied to a motor and excess power loss may occur due to deterioration of efficiency at an uphill load. Therefore, hub motor units of high torque type having no speed-reducing unit and hub motor units having a speed-reducing unit have been developed.

In addition, an exterior or an interior transmission of a conventional bicycle is applied to an electric bicycle so as to reduce load of a motor. Such an exterior or an interior transmission is necessarily used so as to maintain performance of the bicycle when torque of the motor is not supplied due to discharge of a battery and so on.

FIG. 1 is a schematic diagram of an electric bicycle having a conventional hub motor unit.

If a driver rotates a driving sprocket 101 through a pedal, torque is delivered to a driven sprocket 107 of a rear wheel 105 through a chain 103. Therefore, driving torque due to foot effort of the driver as well as torque of a hub motor unit 100 (or a motor portion) is delivered to the rear wheel 105 connected through a spoke 109.

Herein, a motor controller 111 detects the torque due to the foot effort of the driver and rotation speed of the rear wheel 105, and, together with a battery system, controls output of the hub motor unit 100 (or the motor portion) based thereon.

In a case that the exterior transmission is applied as shown in FIG. 2, the torque generated by the foot effort is converted by a gear ratio of the driving sprocket 101 and is delivered to the rear wheel 105. The converted torque is added to the torque generated at the hub motor unit 100 (motor portion) and runs the rear wheel 105.

In a case that the interior transmission is applied, the torque delivered to the driving sprocket 101 is delivered to the rear wheel through the transmission. In addition, the converted torque is added to the torque generated at the hub motor unit 100 (motor portion) and runs the rear wheel 105.

According to conventional arts in which the hub motor unit 100 (motor portion) and the exterior or the interior transmission are used, the exterior or the interior transmission increases the torque due to the foot effort of the driver, and the hub motor unit 100 (motor portion) assists additional torque to the increased torque.

In a case that more torque is assisted by the hub motor unit 100 in the electric bicycle of conventional arts, a speed-reducing unit 200 may be applied to the hub motor unit 100 or a transmission for improving efficiency at high speed and low speed driving regions may be applied to the hub motor unit 100. If additional speed-reducing unit 200 or transmission is used besides the transmission for assisting the foot effort of the driver, weight of the electric bicycle may increases.

In a case that a conventional electric bicycle runs with a low shift-speed at a driving region at which running resistance is large such as uphill driving, the torque delivered to the driven sprocket 107 has low rotation speed with respect to rotation speed of the pedal and is high with respect to the torque due to the foot effort. Since the hub motor unit 100 (or the motor portion) supplies high torque at low rotation speed, overload or efficiency deterioration may not be unavoidable.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a hub motor unit for an electric bicycle having advantages of simplifying structures as a consequence that one shifting portion for improving output characteristics of a motor can assists foot effort of a driver.

Various aspects of the present invention may be directed to providing a hub motor unit for an electric bicycle having further advantages of reducing performance dependency and weight of a motor portion by controlling torque of a motor to rotation speed of the motor.

A hub motor unit for an electric bicycle in an aspect of the present invention may include a hollow shaft mounted at a bicycle frame, a shifting portion having an input element rotatably mounted at the hollow shaft and an output element, a driven sprocket being mounted at the input element, a hub housing rotatably mounted at an exterior circumference of the input element of the shifting portion, and having an interior circumference fixedly connected to the output element of the shifting portion and an exterior circumference connected to a wheel through a spoke, a hub cover rotatably mounted at the hollow shaft and coupled to the hub housing, a motor portion mounted between the hollow shaft and the input element of the shifting portion in the hub housing and supplying torque to the shifting portion through the input element according to a control signal, and a shift control portion mounted on a shift shaft in the hollow shaft and controlling the shifting portion.

The shifting portion may include a plurality of planetary gear sets having the input element and the output element.

A bearing may be interposed between a front portion of the input element and an exterior circumference of the hollow shaft.

A bearing may be interposed between the hub housing and an exterior circumference of the input element of the shifting portion.

The motor portion may include a stator fixed to the hollow shaft in the hub housing, and a rotor mounted along an interior circumference of the input element of the shifting portion corresponding to the stator.

The stator may be fixed to the hollow shaft through a connecting plate.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an electric bicycle having a conventional hub motor unit.

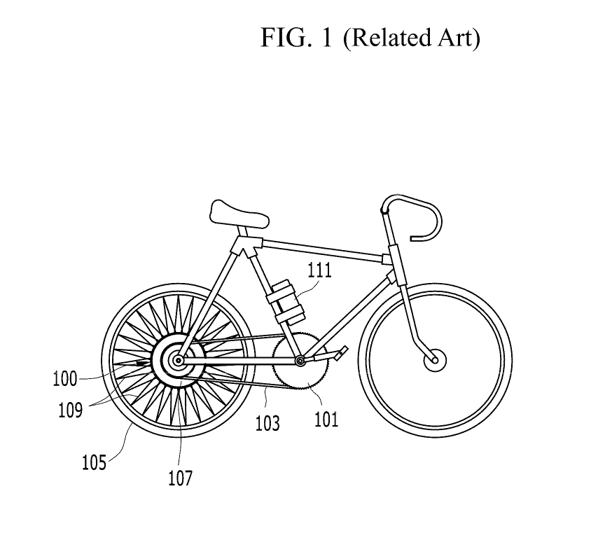

FIG. 2 is a block diagram illustrating power delivery of a conventional hub motor unit.

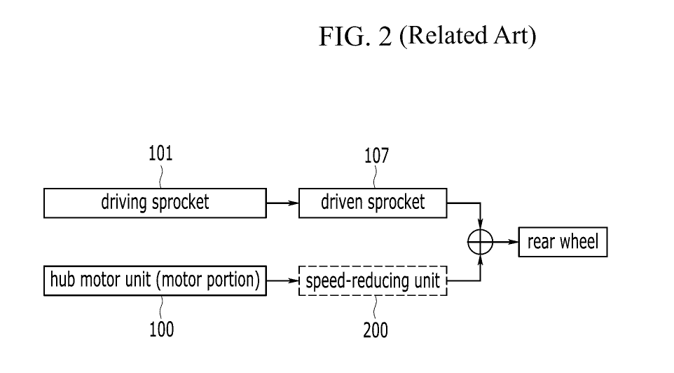

FIG. 3 is a cross-sectional view of a hub motor unit for an electric bicycle according to an exemplary embodiment of the present invention.

FIG. 4 is a block diagram illustrating power delivery of a hub motor unit for an electric bicycle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of he present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described in detail with reference to the accompanying drawings.

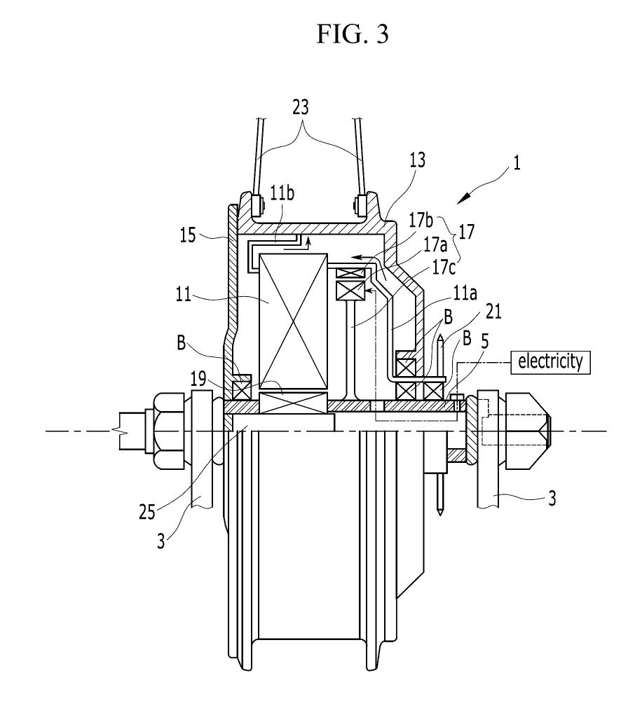

FIG. 3 is a cross-sectional view of a hub motor unit for an electric bicycle according to an exemplary embodiment of the present invention.

Referring to FIG. 3, a hub motor unit 1 for an electric bicycle according to an exemplary embodiment of the present invention is mounted at a hollow shaft 5 that is mounted at a bicycle frame 3.

That is, a shifting portion 11, a hub housing 13, a hub cover 15, a motor portion 17, and a shift control portion 19 are mounted on the hollow shaft 5.

The shifting portion 11 includes an input element 11a and a driven sprocket 21 is mounted at a front portion of the input element 11 a such that the shifting portion 11 can receive foot effort of a driver due to pedaling through a chain as driving torque.

The shifting portion 11 includes a plurality of planetary gear sets having one input element 11a and one output element 11b.

For example, a gear train realizing eight forward speeds by combining three planetary gear sets may be used as the shifting portion 11. The shifting portion 11 may increase or decrease rotation speed input from the motor portion 17. A total gear ratio of the shifting portion 11 including gear ratios of a driving sprocket and the driven sprocket 21 may contain a gear ratio of a conventional bicycle.

At this time, a plurality of bearings B is interposed between the front portion of the input element 11a of the shifting portion 11 and an exterior circumference of the hollow shaft 5 such that the input element 11a is rotatably mounted on the hollow shaft 5.

In addition, a side portion of the hub housing 13 is rotatably mounted at an exterior circumference of the input element 11a of the shifting portion 11, and the other side portion of the hub housing 13 is fixedly connected to the output element 11b of the shifting portion 11. That is, the hub housing 13 can rotate relatively to the input element 11a and can rotate together with the output element 11b.

At this time, a bearing B is interposed between the side portion of the hub housing 13 and the exterior circumference of the input element 11a of the shifting portion 11 such that the hub housing 13 rotates relatively to the input element 11a.

Meanwhile, an exterior circumference of the hub housing 13 is connected to a wheel through a spoke 23.

In addition, the hub cover 15 is assembled to the hub housing 13 such that the hub cover 15 rotates together with the hub housing 13. A bearing B is interposed between the hub cover 15 and the hollow shaft 5 such that the hub cover 15 rotates relatively to the hollow shaft 5.

In addition, the motor portion 17 is mounted between the hollow shaft 5 and the input element 11 a of the shifting portion 11 in the hub housing 13, delivers torque to the shifting portion 11 through the input element 11a according to a control signal.

That is, the motor portion 17 includes a stator 17a and a rotor 17b, and the stator 17a is fixed to the hollow shaft 5 through a connecting plate 17c in the hub housing 13.

In addition, the rotor 17b is mounted along an interior circumference of the input element 11a of the shifting portion 11 so as to rotate corresponding to the exterior circumference of the stator 17a.

In addition, a shift shaft 25 is mounted in the hollow shaft 5, and the shift control portion 19 which controls the shifting portion 11 according to an operation of the shift shaft 25 between the shift shaft 25 and the shifting portion 11 is also mounted at the hollow shaft 5.

Herein, the shift control portion 19 controls operation elements in the shifting portion 11 to be operated as fixed elements or friction elements according to the operation of the shift shaft 25. The shift control portion 19 is well known to a person of an ordinary skill in the art, and thus detailed description thereof will be omitted.

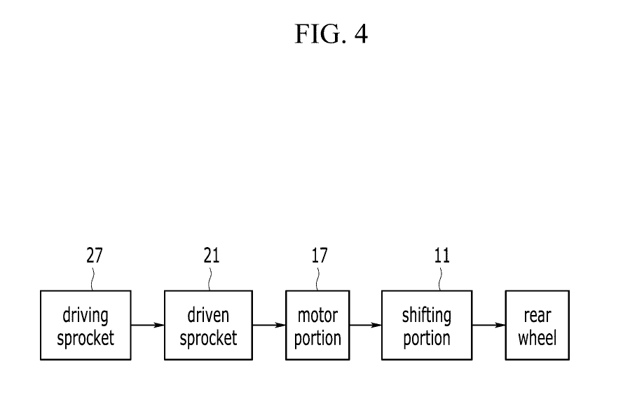

Operation of the hub motor unit 1 for an electric bicycle will be described with reference to FIG. 3 and FIG. 4.

FIG. 4 is a block diagram illustrating power delivery of a hub motor unit for an electric bicycle according to an exemplary embodiment of the present invention.

In the hub motor unit 1 for an electric bicycle according to an exemplary embodiment of the present invention, the driven sprocket 21 as well as the rotor 17b of the motor portion 17 provided in the hub housing 13 is connected to the input element 11a of the shifting portion 11, and the output element 11b of the shifting portion 11 is connected to the hub housing 13, as shown in FIG. 3. Therefore, if electricity is not applied to the motor portion 17, the electric bicycle according to an exemplary embodiment of the present invention operates as a conventional bicycle.

As shown in FIG. 4, driving torque due to foot effort of a driver delivered through the driving sprocket 27 and the driven sprocket 21 is added to torque of the motor portion 17, and total driving torque is delivered to the input element 11a of the shifting portion 11. The total driving torque is converted in the shifting portion 11 and is delivered to the hub housing 13 through the output element 11 b of the shifting portion 11.

Then, the hub housing 13 rotates together with the wheel connected thereto through the spoke 23 and runs a rear wheel.

According to a conventional hub motor unit, torque generated by pedaling is converted by gear ratios of the driving and driven sprockets or is delivered to the rear wheel through a transmission. Therefore, converted torque is added to the torque generated by the motor portion, and total torque runs the rear wheel.

However, the torque generated by the pedaling is converted after being added to the torque generated by the motor portion according to according to an exemplary embodiment of the present invention.

For example, the electric bicycle provided with a conventional hub motor unit runs with a low shift-speed at a driving region at which running resistance is large such as uphill driving, torque delivered through the sprocket has low rotation speed with respect to rotation speed of the pedal and is high with respect to the torque due to the pedaling. Since the motor portion must assist high torque at a low rotation speed, overload or efficiency deterioration may occur.

On the contrary, the electric bicycle provided with the hub motor unit 1 according to an exemplary embodiment of the present invention runs with the low shift-speed, driving torque due to the pedaling is added to the torque of the motor portion 17 before rotation speed decreases at the shifting portion. Even if the electric bicycle runs with a low shift-speed, the motor portion 17 may supply torque of high rotation speed.

As described above, since one shifting portion for improving output characteristics of a motor can assist foot effort of a driver, structure of an electric bicycle may be simplified according to an exemplary embodiment of the present invention.

In addition, since torque of the motor portion with respect to rotation speed of the motor portion can be controlled, performance dependency and weight of the motor portion may be reduced.

For convenience in explanation and accurate definition in the appended claims, the terms “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A hub motor unit for an electric bicycle, comprising:
a hollow shaft mounted at a bicycle frame;
a shifting portion having an input element rotatably mounted at the hollow shaft and an output element, a driven sprocket being mounted at the input element;
a hub housing rotatably mounted at an exterior circumference of the input element of the shifting portion, and having an interior circumference fixedly connected to the output element of the shifting portion and an exterior circumference connected to a wheel through a spoke;
a hub cover rotatably mounted at the hollow shaft and coupled to the hub housing;
a motor portion mounted between the hollow shaft and the input element of the shifting portion in the hub housing and supplying torque to the shifting portion through the input element according to a control signal; and
a shift control portion mounted on a shift shaft in the hollow shaft and controlling the shifting portion.

2. The hub motor unit of claim 1, wherein the shifting portion includes a plurality of planetary gear sets having the input element and the output element.

3. The hub motor unit of claim 1, wherein a bearing is interposed between a front portion of the input element and an exterior circumference of the hollow shaft.

4. The hub motor unit of claim 1, wherein a bearing is interposed between the hub housing and an exterior circumference of the input element of the shifting portion.

5. The hub motor unit of claim 1, wherein the motor portion comprises:
a stator fixed to the hollow shaft in the hub housing; and
a rotor mounted along an interior circumference of the input element of the shifting portion corresponding to the stator.

6. The hub motor unit of claim 5, wherein the stator is fixed to the hollow shaft through a connecting plate.

7. A hub motor unit mounted at an electric bicycle, wherein a shifting portion having an input element and an output element is mounted on a hollow shaft of a bicycle frame, and
wherein a driven sprocket is mounted at the input element of the shifting portion at an exterior of a hub housing, a rotor of a motor portion is mounted at the input element of the shifting portion at an interior of the hub housing, and the output element of the shifting portion is fixedly connected to an interior circumference of the hub housing.

8. The hub motor unit of claim 7, wherein the shifting portion includes a plurality of planetary gear sets having the input element and the output element.

9. The hub motor unit of claim 7, wherein a bearing is interposed between a front portion of the input element and an exterior circumference of the hollow shaft.

10. The hub motor unit of claim 7, wherein a bearing is interposed between the hub housing and an exterior circumference of the input element of the shifting portion.
